(19) United States
(12) Patent Application Publication
(10) Pub. No.: US 2008/0050672 A1
(43) Pub. Date: Feb. 28, 2008

(54) LIGHT ACTIVATED CONTRAST SYSTEMS USING MASKED DEVELOPERS FOR OPTICAL DATA RECORDING

(76) Inventor: Makarand P. Gore, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/844,557

(22) Filed: Aug. 24, 2007

Related U.S. Application Data
(60) Provisional application No. 60/840,279, filed on Aug. 24, 2006.
(60) Provisional application No. 60/827,814, filed on Oct. 2, 2006.

(51) Int. Cl. G11B 7/24

(52) U.S. Cl. 430/270.11; 430/270.1

(57) ABSTRACT

An optical data recording medium includes a substrate and a markable coating on the substrate. The markable coating includes a radiation absorber, a leuco dye, a developer and a deprotection agent.

### CROSS-REFERENCE TO RELATED APPLICATIONS

The present application claims the benefit of provisional application Ser. No. 60/840,279, filed Aug. 24, 2006, and provisional application Ser. No. 60/827,814, filed Oct. 2, 2006, the contents of both of which are hereby incorporated by reference.

### BACKGROUND

Materials that produce color change upon stimulation with radiation are used in optical recording and imaging media and devices. Further, widespread adoption of and rapid advances in technologies relating to optical recording and imaging media have created a desire for greatly increased data storage capacity in such media. Thus, optical storage technology has evolved from the compact disc (CD) and laser disc (LD) to far denser data types such as digital versatile disc (DVD) and blue laser formats such as BLU-RAY and high-density DVD (HD-DVD). “BLU-RAY” and the BLU-RAY Disc logo mark are trade-marks of the BLU-RAY Disc Founders, which consists of 13 companies in Japan, Korea, Europe, and the U.S.

In each case, the optical recording medium comprises a substrate, typically a disc, on which is deposited a layer on which a mark can be created. In some media the mark is a “pit,” or indentation in the surface of the layer, and the spaces between pits are called “lands.” In other media, the mark is a localized region in which the optical properties, such as reflectivity or transparency, are modified. A marked disc can be read by directing a laser beam at the marked surface and recording changes in the reflected beam as the beam moves across the surface of the medium. An optical recording medium consists of any surface coated with a material that can be read using an incident light beam.

It remains desirable to improve the markability and manufacturability of optical recording media and increase data density thereon while reducing cost and complexity.

### BRIEF DESCRIPTION OF THE DRAWINGS

Features and advantages of embodiment(s) of the present disclosure will become apparent by reference to the following detailed description and the drawings, in which like reference numerals correspond to similar, though perhaps not identical components. Reference numerals having a previously described function may or may not be described in connection with other drawings in which they appear.

FIG. 1 is a perspective view and block diagram illustrating an embodiment of an optical disc recording system;

FIG. 2 is a side elevation view of an embodiment of a recordable optical disc shown in conjunction with a partial block diagram of some of the elements of the system represented in FIG. 1; and

FIG. 3 is a chemical diagram illustrating an exemplary deprotection and reaction.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “comprising, but not limited to . . . .”

Reference is made herein to BLU-RAY technologies. Disc specifications for BLU-RAY discs currently include the following: wavelength=405 nm; numerical aperture (NA)=0.85; disc diameter=12 cm; disc thickness=1.2 mm; and data capacity≧23.3/25/27 GB. BLU-RAY discs can currently be used to store 2 hours high resolution video images or 13 hours conventional video images. A blue-violet laser having a wavelength range between 380 nm and 420 nm, and particularly 405 nm is used as the light source for BLU-RAY discs. Another example of storage media and technology using blue light (380˜420nm radiation) is HD-DVD. Furthermore, “Hybrid” media, methods and devices capable of writing and reading at 405 nm, 650 nm and 780 nm±30 nm are in development.

As used herein, the term “leuco dye” refers to a color-forming substance that is colorless or one color in a non-activated state and that produces or changes color in an activated state. As used herein, the terms “developer” and “develop” describe a substance that reacts with the dye and causes the dye to alter its chemical structure and change or acquire color.

The term “light” as used herein includes electromagnetic radiation of any wavelength or band and from any source, such as a LASER diode or LED.

### DETAILED DESCRIPTION

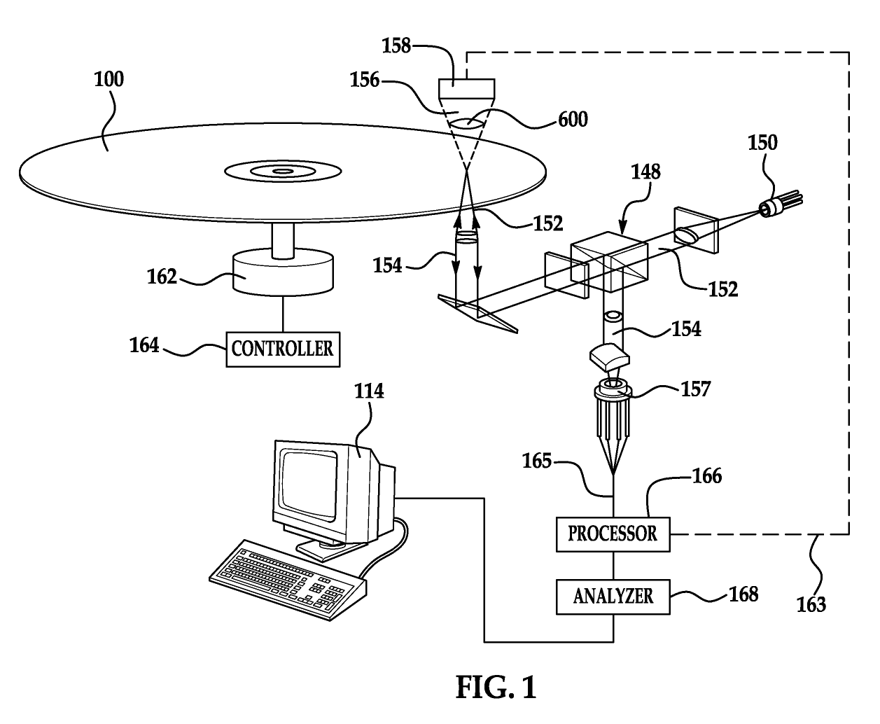

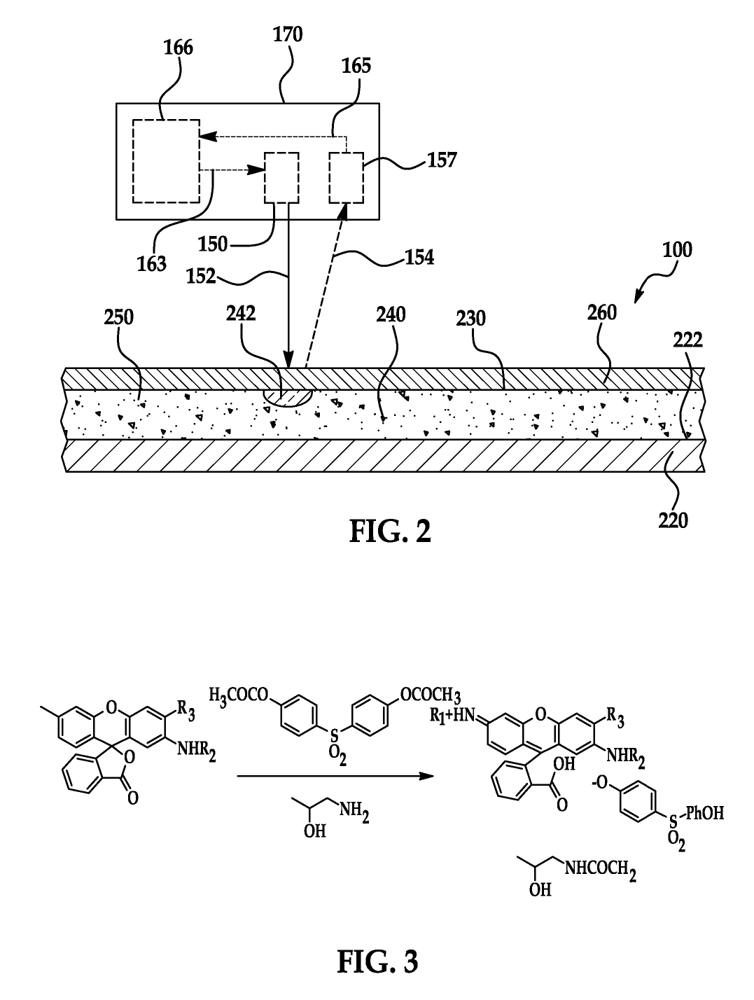

Referring to FIG. 1, there is shown a representation in perspective and block diagram illustrating optical components 148, a light source 150 that produces the incident or interrogation energy beam 152, a return beam 154 which is detected by the pickup 157, and a transmitted beam 156. In the transmissive optical disc form, the transmitted beam 156 is detected by a top detector 158 via lens or optical system 600, and is also analyzed for the presence of signal agents. In the transmissive embodiment, a photo detector may be used as a top detector 158. FIG. 2 shows an abbreviated block diagram of the read/write system 170 illustrating some of the same optical components.

FIG. 1 also illustrates a drive motor 162 and a controller 164 for controlling the rotation of the optical disc/imaging medium 100. FIG. 1 further shows a processor 166 and analyzer 168 implemented in the alternative for processing the return beam 154 with a signal 165 from the pickup 157 to the processor 166, as well as processing a transmitted beam 156 from a signal 163 transmitted from the optical detector 158 and associated with the transmissive optical disc format. A display monitor 114 is also provided for displaying the results of the processing.

Referring briefly to FIG. 2, there is shown in a partial block diagram the read/write system 170 that applies an energy beam 152 onto the imaging medium 100. Imaging medium 100 comprises a substrate 220 and a marking layer 230 on a surface 222 thereof. In the embodiment shown, imaging medium 100 further comprises a protective layer 260.

As described in detail below, marking layer 230 preferably comprises a color-forming agent 240 dissolved in a matrix or binder 250. Marking layer 230 may comprise a polymeric matrix and may include an optional fixing agent and/or a radiation absorber (not shown).

Substrate 220 may be any substrate upon which it is desirable to make a mark, such as, by way of example, the polymeric substrate of a CD-R/RW/ROM, DVD±R/RW/ROM, HD-DVD or BLU-RAY disc. Substrate 220 may be paper (e.g., labels, tickets, receipts, or stationery), overhead transparency, or other surface upon which it is desirable to provide marks. Marking layer 230 may be applied to substrate 220 via any acceptable method, such as, by way of example, rolling, spin-coating, spraying, lithography, or screen printing.

When it is desired to make a mark, marking energy 152 is directed in a desired manner at imaging medium 100. The form of the energy may vary depending upon the equipment available, ambient conditions, and desired result. Examples of energy (also referred to as radiation) that may be used include, but are not limited to, infra-red (IR) radiation, ultra-violet (UV) radiation, x-rays, or visible light. In these embodiments, imaging medium 100 is illuminated with light having the desired predetermined wavelength at the location where it is desired to form a mark. The marking layer 230 absorbs the radiation at an absorption wavelength range selected from the group consisting of 370 nm to 380 nm, 380 nm to 420 nm, 400 nm to 415 nm, 468 nm to 478 nm, 650 nm to 660 nm, 780 nm to 787 nm, 970 nm to 990 nm, and 1520 nm to 1580 nm, causing a change in marking layer 130 and thereby producing an optically detectable mark 242.

The color-forming agent 240 may be any substance that undergoes a detectable optical change in response to a threshold stimulus, which may be applied in the form of light or heat. In some embodiments, the color-forming agent comprises a leuco dye and a developer, as described in detail below. The developer and the leuco dye produce a detectable optical change when chemically mixed. The concentration and distribution of the color-forming components 240 in marking layer 230 are preferably sufficient to produce a detectable mark when activated.

In many embodiments, it is desirable to provide a marking layer 230 that is less than one micron (μm) thick. In order to achieve this, spin coating is a suitable application technique. In addition, it is desirable to provide a marking composition that is capable of forming a layer occupying the predetermined thickness. Thus, in such cases, the marking layer should be, inter alia, free from particles that would prevent such a layer, i.e., free from particles having a dimension greater than 1 μm.

Furthermore, in many applications it may be desirable to provide a markable coating that is transparent. In such a case, any particles present in the coating would need to have an average size less than the wavelength of the light to which the coating is transparent. While a coating in which all particles are smaller than 1 μm would serve this purpose, a coating in which the marking components are dissolved is preferred over one in which they are present as particles. Still further, as target data densities increase, the dot size, or mark size, that can be used for data recording decrease. Some currently available technologies require an average dot size of 1 μm or less. For all of these reasons, marking layer 230 is therefore preferably, but not necessarily, entirely free of particles.

In a marking layer in which both color-forming components 240 are dissolved, it is necessary to prevent the color-forming components 240 from combining prematurely and generating an optical change across the entire marking layer. According to certain embodiments, this can be accomplished by providing a protective moiety on either the dye or the developer. In preferred embodiments, the protective moiety is provided on the developer and a deprotection agent is included in the marking layer. In alternative embodiments, the protective moiety is provided on the dye. In either embodiment, an increase in temperature causes the protective moiety to be removed from the developer. Removal of the protective moiety exposes an active acid and leaves the developer free to react with the leuco dye. Thus, once the developer has been deprotected by the deprotection agent, a color-forming reaction occurs between the developer and the dye. Thus, if sufficient energy is applied to the desired region of marking layer 230, an optically detectable mark 242 can be produced.

The resulting mark 242 can be detected by an optical sensor, thereby producing an optically readable device. Depending on the color-forming agent 240 selected, the marking composition may become relatively more or relatively less absorbing at a desired wavelength upon activation. Because many commercial and consumer products use a single wavelength for both read and write operations, and because a color-forming agent 240 that produces a mark that is relatively absorbing (relative to the unmarked regions) at the read wavelength may be particularly advantageous, it is desirable to provide a color-forming agent 240 that produces a mark that is relatively absorbing at the read/write wavelength.

Thus, by way of example only, if blue-violet light (radiation) is to be used as the read radiation, the marks formed in the marking layer are preferably a contrasting color, namely yellow to orange, indicating absorption of blue radiation. In certain embodiments, therefore, the marking composition contains a leuco dye that, when activated, changes from being relatively non-absorbing at blue-violet wavelengths to being relatively absorbing at those wavelengths.

Nonetheless, the embodiments disclosed herein are not limited to such dyes. Specific examples of other suitable leuco dyes include fluorans and phthalides, which include but are not limited to the following and which can be used alone or in combination: 1,2-benzo-6-(N-ethyl-N-toluidino)fluoran, 1,2-benzo-6-(N-methyl-N-cyclohexylamino)-fluoran, 1,2-benzo-6-dibutylaminofluoran, 1,2-benzo-6-diethylaminofluran, 2-(α-phenylethylamino)-6-(N-ethyl-p-toluidino)fluoran, 2-(2,3-dichloroanilino)-3-chloro-6-diethylaminofluran, 2-(2,4-dimethylanilino)-3-methyl-6-diethylaminofluoran, 2-(di-p-methylbenzilamino)-6-(N-ethyl-p-toluidino)fluoran, 2-(m-trichloromethylanilino)-3-methyl-6-(N-cyclohexyl-N-methylamino)fluoran, 2-(m-trichloromethylanilino)-3-methyl-6-diethylanimofluoran, 2-(m-trifluoromethylaniline)-6-diethylaminofluoran, 2-(m-trifluoromethylanilino)-3-chloro-6-diethylaminofluran, 2-(m-trifluoromethylanilino)-3-methyl-6-diethylanimofluoran, 2-(N-ethyl-p-toluidino)-3-methyl-6-(N-ethylanilino)fluoran, 2-(N-ethyl-p-toluidino)-3-methyl-6-(N-propyl-p-toluidino)fluoran, 2-(o-chloroanilino)-3-chloro-6-diethlaminofluoran, 2-(o-chloroanilino)-6-dibutylaminofluoran, 2-(o-chloroanilino)-6-diethylaminofluoran, 2-(p-acetylanilino)-6-(N-n-amyl-N-n-butylamino)fluoran, 2,3-dimethyl-6-dimethylaminofluoran, 2-amino-6-(N-ethyl-2,4-dimethylanilino)fluoran, 2-amino-6-(N-ethylanilino)fluoran, 2-amino-6-(N-ethyl-p-chloroanilino)fluoran, 2-amino-6-(N-ethyl-p-ethylanilino)fluoran, 2-amino-6-(N-ethyl-p-toluidino)fluoran, 2-amino-6-(N-methyl-2,4-dimethylanilino)fluoran, 2-amino-6-(N-methylanilino)fluoran, 2-amino-6-(N-methyl-p-chloroanilino)fluoran, 2-amino-6-(N-methyl-p-ethylanilino)fluoran, 2-amino-6-(N-methyl-p-toluidino)fluoran, 2-amino-6-(N-propyl-2,4-dimethylanilino)fluoran, 2-amino-6-(N-propylanilino)fluoran, 2-amino-6-(N-propyl-p-chloroanilino)fluoran, 2-amino-6-(N-propyl-p-ethylanilino)fluoran, 2-amino-6-(N-propyl-p-toluidino)fluoran, 2-anilino-3-chloro-6-diethylaminofluran, 2-anilino-3-methyl-6-(N-cyclohexyl-N-methylamino)fluoran, 2-anilino-3-methyl-6-(N-ethyl-N-isoamylamino)fluoran, 2-anilino-3-methyl-6-(N-ethyl-N-p-benzyl)aminofluoran, 2-anilino-3-methyl-6-(N-ethyl-N-propylamino)fluoran, 2-anilino-3-methyl-6-(N-iso-amyl-N-ethylamino)fluoran, 2-anilino-3-methyl-6-(N-isobutyl-methylamino)fluoran, 2-anilino-3-methyl-6-(N-isopropyl-methylamino)fluoran, 2-anilino-3-methyl-6-(N-methyl-p-toluidino-)fluoran, 2-anilino-3-methyl-6-(N-n-amyl-N-ethylamino)fluoran, 2-anilino-3-methyl-6-(N-n-amyl-N-methylamino)fluoran, 2-anilino-3-methyl-6-(N-n-propyl-N-isopropylamino)fluoran, 2-anilino-3-methyl-6-(N-n-propyl-N-methylamino)fluoran, 2-anilino-3-methyl-6-(N-sec-butyl-N-methylamino)fluoran, 2-anilino-3-methyl-6-diethylaminofluoran, 2-anilino-3-methyl-6-di-n-butylaminofluoran, 2-anilino-6-(N-n-hexyl-N-ethylamino)fluoran, 2-benzilamino-6-(N-ethyl-2,4-dimethylanilino)fluoran, 2-benzilamino-6-(N-ethyl-p-toluidino)fluoran, 2-benzilamino-6-(N-methyl-2,4-dimethylanilino)fluoran, 2-benzilamino-6-(N-methyl-p-toluidino)fluoran, 2-bromo-6-diethylaminofluoran, 2-chloro-3-methyl-6-diethylaminofluran, 2-chloro-6-(N-ethyl-N-isoamylamino)fluoran, 2-chloro-6-diethylaminofluoran, 2-chloro-6-dipropylaminofluoran, 2-diethylamino-6-(N-ethyl-p-toluidino)fluoran, 2-diethylamino-6-(N-methyl-p-toluidino)fluoran, 2-dimethylamino-6-(N-ethylanilino)fluoran, 2-dimethylamino-6-(N-methylanilino)fluoran, 2-dipropylamino-6-(N-ethylanilino)fluoran, 2-dipropylamino-6-(N-methylanilino)fluoran, 2-ethylamino-6-(N-ethyl-2,4-dimethylanilino)fluoran, 2-ethylamino-6-(N-methyl-p-toluidino)fluoran, 2-methylamino-6-(N-ethylanilino)fluoran, 2-methylamino-6-(N-methyl-2,4-dimethylanilino)fluoran, 2-methylamino-6-(N-methylanilino)fluoran, 2-methylamino-6-(N-propylanilino)fluoran, 3-(1-ethyl-2-methylindole-3-yl)-3-(2-ethoxy-4-diethylaminophenyl)-4-azaphthalide, 3-(1-ethyl-2-methylindole-3-yl)-3-(2-ethoxy-4-diethylaminophenyl)-7-azaphthalide, 3-(1-ethyl-2-methylindole-3-yl)-3-(2-methyl-4-diethylaminophenyl)-4-azaphthalide, 3-(1-ethyl-2-methylindole-3-yl)-3-(2-methyl-4-diethylaminophenyl)-7-azaphthalide, 3-(1-ethyl-2-methylindole-3-yl)-3-(4-diethylaminophenyl)-4-azaphthalide, 3-(1-ethyl-2-methylindole-3-yl)-3-(4-N-n-amyl-N-methylaminophenyl)-4-azaphthalide, 3-(1-methyl-2-methylindole-3-yl)-3-(2-hexyloxy-4-diethylaminophenyl)-4-azaphthalide, 3-(1-ethyl-2-methylindole-3-yl)-3-(2-ethoxy-4-diethylaminophenyl)-4-azaphthalide, 3-(N-cyclohexyl-N-methylamino)-6-methyl-7-phenylaminofluoran, 3-(N-ethyl-N-isoamylamino)-6-methyl-7-phenylaminofluoran, 3-(N-ethyl-p-toluidino)-6-methyl-7-phenylaminofluoran, 3,3-bis(2-ethoxy-4-diethylaminphenyl)-4-azaphthalide, 3,3-bis(2-ethoxy-4-diethylaminphenyl)-7-azaphthalide, 3,6-dibutoxyfluoran, 3,6-diethoxyfluoran, 3,6-dimethoxyfluoran, 3-bromo-6-cyclohexylaminofluoran, 3-chloro-6-cyclohexylaminofluoran, 3-dibutylamino-7-(o-chloro-phenylamino)fluoran, 3-diethylamino-5-methyl-7-dibenzylaminofluoran, 3-diethylamino-6-(m-trifluoromethylanilino)fluoran, 3-diethylamino-6,7-dimethylfluoran, 3-diethylamino-6-methyl-7-xylidinofluoran, 3-diethylamino-7-(2-carbomethoxy-phenylamino)fluoran, 3-diethylamino-7-(N-acetyl-N-methylamino)fluoran, 3-diethylamino-7-(N-chloroethyl-N-methylamino)fluoran, 3-diethylamino-7-(N-methyl-N-benzylamino)fluoran, 3-diethylamino-7-(o-chlorophenylamino)fluoran, 3-diethylamino-7-chlorofluoran, 3-diethylamino-7-dibenzylaminofluoran, 3-diethylamino-7-diethylaminofluoran, 3-diethylamino-7-N-methylaminofluoran, 3-dimethylamino-6-methoxylfluoran, 3-dimethylamino-7-methoxyfluoran, 3-methyl-6-(N-ethyl-p-toluidino)fluoran, 3-piperidino-6-methyl-7-phenylaminofluoran, 3-pyrrolidino-6-methyl-7-p-butylphenylaminofluoran, and 3-pyrrolidino-6-methyl-7-phenylaminofluoran.

Additional dyes that may be alloyed in accordance with the embodiments disclosed herein include, but are not limited to leuco dyes such as fluoran leuco dyes and phthalide color formers as are described in “The Chemistry and Applications of Leuco Dyes,” Muthyala, Ramiah, ed., Plenum Press (1997) (ISBN 0-306-45459-9). Embodiments may comprise almost any known leuco dye, including, but not limited to, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2-(p-hydroxyphenyl)-4,5-diphenylimidazoles, indanones, leuco indamines, hydrozines, leuco indigoid dyes, amino-2,3-dihydroanthraquinones, tetrahalo-p,p′-biphenols, 2-(p-hydroxyphenyl)-4,5-diphenylimidazoles, phenethylanilines, and mixtures thereof.

Particularly suitable leuco dyes include: Specialty Yellow 37 (Noveon), NC Yellow 3 (Hodogaya), Specialty Orange 14 (Noveon), Perga Script Black IR (CIBA), and Perga Script Orange IG (CIBA).

Additional examples of dyes include: Pink DCF CAS#29199-09-5; Orange-DCF, CAS#21934-68-9; Red-DCF CAS#26628-47-7; Vemmilion-DCF, CAS#117342-26-4; Bis(dimethyl)aminobenzoyl phenothiazine, CAS#1249-97-4; Green-DCF, CAS#34372-72-0; chloroanilino dibutylaminofluoran, CAS#82137-81-3; NC-Yellow-3 CAS#36886-76-7; Copikem37, CAS#144190-25-0; Copikem3, CAS#22091-92-5, available from Hodogaya, Japan or Noveon, Cincinnati, USA.

Additional non-limiting examples of suitable fluoran-based leuco dyes include: 3-diethylamino-6-methyl-7-anilinofluoran, 3-(N-ethyl-p-toluidino)-6-methyl-7-anilinofluoran, 3-(N-ethyl-N-isoamylamino)-6-methyl-7-anilinofluoran, 3-diethylamino-6-methyl-7-(o,p-dimethylanilino)fluoran, 3-pyrrolidino-6-methyl-7-anilinofluoran, 3-piperidino-6-methyl-7-anilinofluoran, 3-(N-cyclohexyl-N-methylamino)-6-methyl-7-anilinofluoran, 3-diethylamino-7-(m-trifluoromethylanilino)fluoran, 3-dibutylamino-6-methyl-7-anilinofluoran, 3-diethylamino-6-chloro-7-anilinofluoran, 3-dibutylamino-7-(o-chloroanilino)fluoran, 3-diethylamino-7-(o-chloroanilino)fluoran, 3-di-n-pentylamino-6-methyl-7-anilinofluoran, 3-di-n-butylamino-6-methyl-7-anilinofluoran, 3-(n-ethyl-n-isopentylamino)-6-methyl-7-anilinofluoran, 3-pyrrolidino-6-methyl-7-anilinofluoran, 1(3H)-isobenzofluranone, 3-bis [2-[4-(dimethylamino)phenyl]-2-(4-methoxyphenyl)ethenyl]4,5,6,7-tetrachloro phthalide, and mixtures thereof. Aminotriarylmethane leuco dyes may also be used in embodiments of the present disclosure, such as tris(N,N-dimethylaminophenyl)methane (LCV); tris(N,N-diethylaminophenyl)methane (LECV); tris(N,N-di-n-propylaminophenyl)methane (LPCV); tris(N,N-di-n-butylaminophenyl)methane (LBCV); bis(4-diethylaminophenyl)-(4-diethylamino-2-methyl-phenyl)methane (LV-1); bis(4-diethylamino-2-methylphenyl)-(4-diethylamino-phenyl)methane (LV-2); tris(4-diethylamino-2-methylphenyl)methane (LV-3); bis(4-diethylamino-2-methylphenyl)(3,4-diemethoxyphenyl)methane (LB-8); aminotriarylmethane leuco dyes having different alkyl substituents bonded to the amino moieties wherein each alkyl group is independently selected from C₁-C₄ alkyl; and aminotriarylmethane leuco dyes with any of the preceding named structures that are further substituted with one or more alkyl groups on the aryl rings wherein the latter alkyl groups are independently selected from C₁-C₃ alkyl.

The protected developers may include protected phenols. If sufficient energy is applied to the protected developer in the presence of a deprotection agent, the protective moiety, which may be an acyl group, is deprotected by the deprotection agent, thereby exposing the functional acid group(s) of the developer. The unprotected developer can then react with the leuco dye to form a colored dye. In some embodiments, energy or radiation is supplied in the form of heat, which may in turn be supplied by the absorption of incident light or any other suitable means, and a mark 242 is made by heating a region of markable layer 230 above a threshold temperature. An exemplary deprotection and reaction scheme is illustrated in FIG. 2, in which an acyl-protected phenol is deprotected by transfer of the acyl moiety to an amine.

In certain embodiments, the threshold temperature is at least 95° C., or ranges from about 95° C. to about 250° C. In other embodiments, a detectable mark is formed when the temperature of the marking layers reaches from about 250° C. to about 400° C.

Developers

A wide variety of developers can be protected using various protective moieties. Attachment of a protective moiety onto a developer by a chemical bond(s) can be carried out according to conventionally known methods such as those described in Greene, TW and Wuts, PGM “Protective Groups in Organic Synthesis”, John Wiley, N.Y., 2nd Edition (1991), the disclosure of which is hereby incorporated herein by reference in its entirety (see especially pages 246-292). Another resource describing such mechanisms is J. F. W. McOmie, “Protective Groups in Organic Chemistry”, Plenum Press (1973), which is also incorporated herein by reference in its entirety.

Although a variety of methods can be utilized to form the protected developers, such as those described in Greene and McOmie, the following examples illustrate several mechanisms for protecting an acid developer. Phenolic and catechol developers can be protected by acylation and condensation reactions with an acyl chloride, acyl anhydride, or activated ester such as succinimidyl ester. Such acylation and condensation reactions can be performed in the presence of a base, such as NaOH, or simply by heating. Alternatively, the reaction can be performed by mixing an amine such as triethyl amine with a dipolar aprotic solvent e.g. acetonitrile or dioxane, followed by an aqueous work up (addition of water and subsequent extraction of the protected developer using ether or the like) or evaporation and purification.

More specifically, the developers may contain various functional groups, such as, hydroxy, thio and amine groups, which act as Lewis acids. After the protective moiety reacts with the functional group, the resulting protected developer can be an ester, ether, sulfonate, carbonate, carbamate, or phosphinate. Examples of specific protected developers include trifluoroacetate, 2-trimethylsilyl ethyl ester, t-butyl ester, p-nitrobenzyl ester, nitrobutyl ester, and trichloroethyl ester.

Examples of acidic materials that may be used as developers include, without limitation, phenols, carboxylic acids, cyclic sulfonamides, protonic acids, and compounds having a pKa of less than about 7.0, and mixtures thereof. Specific phenolic and carboxylic developers can include, without limitation, boric acid, oxalic acid, maleic acid, tartaric acid, citric acid, succinic acid, benzoic acid, stearic acid, gallic acid, salicylic acid, 1-hydroxy-2-naphthoic acid, o-hydroxybenzoic acid, m-hydroxybenzoic acid, 2-hydroxy-p-toluic acid, 3,5-xylenol, thymol, p-t-butylphenyl, 4-hydroxyphenoxide, methyl-4-hydroxybenzoate, 4-hydroxyacetophenone, α-naphthol, naphthols, catechol, resorcin, hydroquinone, 4-t-octylcatechol, 4,4′-butylidenephenol, 2,2′-dihydroxydiphenyl, 2,2′-methylenebis(4-methyl-6-t-butyl-phenol), 2,2′-bis(4′-hydroxyphenyl)propane, 4,4′-isopropylidenebis(2-t-butylphenol), 4,4′-secbutylidenediphenol, pyrogallol, phloroglucine, phlorogluocinocarboxylic acid, 4-phenylphenol, 2,2′-methylenebis(4-chlorophenyl), 4,4′-isopropylidenediphenol, 4,4′-isopropylidenebis(2-chlorophenol), 4,4′-isopropylidenebis(2-methylphenol), 4,4′-ethylenebis(2-methylphenol), 4,4′-thiobis(6-t-butyl-3-methylphenol), bisphenol A and its derivatives (such as 4,4′-isopropylidenediphenol(bisphenol A)), 4-4′-cyclohexylidenediphenol, p,p′-(1-methyl-n-hexylidene)diphenol, 1,7-di(4-hydroxyphenylthio)-3,5-di-oxaheptane), 4-hydroxybenzoic esters, 4-hydroxyphthalic diesters, phthalic monoesters, bis(hydroxyphenyl)sulfides, 4-hydroxyarylsulfones, 4-hydroxyphenylarylsulfonates, 1,3-di[2-(hydroxyphenyl)-2-propyl]benzenes, 1,3-dihydroxy-6(α,α-dimethylbenzyl)benzene, resorcinols, hydroxybenzoyloxybenzoic esters, bisphenolsulfones, bis-(3-allyl-4-hydroxyphenyl)sulfone (TG-SA), bisphenolsulfonic acids, 2,4-dihydroxy-benzophenones, novolac type phenolic resins, polyphenols, saccharin, 4-hydroxy-acetophenone, p-phenylphenol, benzyl-p-hydroxybenzoate(benzalparaben), 2,2-bis(p-hydroxyphenyl)propane, p-tert-butylphenol, 2,4-dihydroxy-benzophenone, hydroxy benzyl benzoates, and p-benzylphenol.

In one embodiment, the developer is a phenolic compound. In a more detailed aspect, the developer can be a bisphenol, such as bis(4-hydroxy-3-allylphenyl)sulphone (TG-SA). In yet another embodiment, the developer compound is a carboxylic acid selected from the group consisting of boric acid, oxalic acid, maleic acid, tartaric acid, citric acid, succinic acid, benzoic acid, stearic acid, gallic acid, salicylic acid, ascorbic acid, and mixtures thereof.

Protective Moieties

As mentioned above, the functional groups of the developers disclosed herein are each protected by a protective moiety. In one aspect, the protective moiety provides a mechanism for protecting the acid functional group of the developer. If the functional group of the developer is a hydroxy group, suitable protecting groups include, for example esters, sulfonates, ethers, phosphinates, carbonates, carbamates (i.e. esters of carbamic acid), and mixtures thereof. In one embodiment, the protective moiety is an acyl group.

A variety of ethers can be used as protective moieties, such as, for example, silyl ethers, alkyl ethers, aromatic ethers, and mixtures thereof. Several non-limiting examples of ethers suitable for use in the present disclosure include methyl ether, 2-methoxyethoxymethyl ether (MEM), cyclohexyl ether, o-nitrobenzyl ether, 9-anthryl ether, tetrahydrothiopyranyl, tetrahydrothiofuranyl, 2-(phenylselenyl)ethyl ether, benzyloxymethyl ethers, methoxyethoxymethyl ethers, 2-(trimethylsilyl)ethoxymethyl ether, methylthiomethyl ether, phenylthiomethyl ether, 2,2-dichloro-1,1-difluoroethyl ether, tetrahydropyranyl, phenacyl, phenylacetyl, propargyl, p-bromophenacyl, cyclopropylmethyl ether, allyl ether, isopropyl ether, t-butyl ether, benzyl ether, 2,6-dimethylbenzyl ether, 4-methoxybenzyl ether, o-nitrobenzyl ether, 2-bromoethyl ether, 2,6-dichlorobenzyl ether, 4-(dimethylaminocarbonyl)benzyl ether, 9-anthrymethyl ether, 4-picolyl ether, heptafluoro-p-tolyl ether, tetrafluoro-4-pyridyl ether, silyl ethers (e.g., trimethylsilyl, t-butyldimethylsilyl, t-butyldiphenylsilyl, butyidiphenylsilyl, tribenzylsilyl, triisopropylsilyl, isopropyldimethylsilyl, 2-trimethylsilyl, 2-(trimethylsilyl)ethoxymethyl (SEM) ether, and mixtures thereof.

Several non-limiting examples of esters suitable for use as protective moieties in the present invention include formate ester, acetate ester, isobutyrate ester, levulinate ester, pivaloate ester, aryl pivaloate esters, aryl methanesulfonate esters, adamantoate ester, benzoate ester, 2,4,6-trimethylbenzoate(mesitoate)ester, 2-trimethyl silyl ester, 2-trimethylsilyl ethyl ester, t-butyl ester, p-nitrobenzyl ester, nitrobutyl ester, trichloroethyl ester, any alkyl branched or aryl substituted ester, 9-fluorenecarboxylate, xanthenecarboxylate, and mixtures thereof. In one embodiment, the protective moiety can be any of formate, acetate, isobutyrate, levulinate, pivaloate, and mixtures thereof.

Several non-limiting examples of carbonates and carbamates suitable for use as protective moieties include 2,2,2-trichloroethyl carbonate, vinyl carbonate, benzyl carbonate, methyl carbonate, p-nitrophenyl carbonate, p-nitrobenzyl carbonate, S-benzyl thiocarbonate, N-phenylcarbamate, 1-adamantyl carbonate, t-butyl carbonate, 4-methylsulfinylbenzyl, 2,4-dimethylbenzyl, 2,4-dimethylpent-3-yl, aryl carbamates, methyl carbamate, benzyl carbamate, cyclic borates and carbonates, and mixtures thereof.

Several non-limiting examples of suitable phosphinates include dimethylphosphinyl, dimethylthiophosphinyl, dimethylphosphinothioyl, diphenylphosphothioyl, and mixtures thereof.

Several non-limiting examples of sulfonates suitable for use in embodiments of the present disclosure include methanesulfonate, toluenesulfonate, 2-formylbenzenesulfonate, and mixtures thereof.

Exemplary protective moieties for hydroxyl functional groups of developers include, for example, t-butyloxycarbonyl, allyloxycarbonyl, benzyloxycarbonyl, o-nitrobenzyloxycarbonyl, and trifluoroacetate.

Deprotection Agents

In order to facilitate removal of the protective moiety from the protected developer, preferred embodiments of marking layer 130 include a deprotection agent. This ingredient facilitates removal of the protective moiety from the developer, thereby allowing the color-forming reaction to occur. In some embodiments, transfer of the protective moiety is stimulated by the application of heat. In some embodiments, the deprotection agent provides a mechanism for removing the above-described protective moieties via a chemical reaction therewith. Although it is recognized that the chemistry of some protective moieties would not always require a separate deprotection agent, such deprotection agents are considered to improve, at least in some instances, the stability and development of the leuco dyes in accordance with the principles of the present disclosure.

Suitable deprotection agents include, without limitation, amines such as α-hydroxy amines, α-amino alcohols, primary amines and secondary amines. In one aspect of the present invention, the deprotection agent can be valoneol, prolinol, 2-hydroxy-1-amino-propanol, 2-amino-3-phenyl-1-propanol, (R)-(−)-2-phenyl glycinol, 2-amino-phenylethanol, 1-naphthylethyl amine, 1-aminonaphthalene, morpholin, and the like. In another aspect, suitable deprotection agents include amines such as those boiling above 95° C. and more preferably above 110° C., including but not limited to 2-amino-3-phenyl-1-propanol, (R)-(−)-2-phenyl glycinol, 2-amino-phenylethanol, or others, such as 1-naphthyl ethyl amine, 1-aminonaphthalene, morpholin, and the like.

The deprotection agent can be present at any concentration that is sufficient to react with enough protective moieties to allow a detectable color change in the leuco dye at the intended level of heat input. It will be understood that the concentration of the deprotection agent can be tailored to affect the speed and degree of the reaction upon exposure to heat. However, as a general guideline, the deprotection agent to developer molar ratio can range from about 10:1 to about 1:4, and in certain embodiments can range from about 1:1 to about 1:2.

In one embodiment, the color forming compositions disclosed herein can include from about 6% to about 45% by weight of protected developer. In another embodiment, the protected developer may be present in an amount ranging from about 20% to about 40% by weight. In still a further detailed aspect, the protected developer may be present in an amount ranging from about 25% to about 38% by weight.

As mentioned above, when the color-forming agent 240 includes a color former, such as a leuco dye, and a protected developer, the matrix can be provided as a homogeneous, single-phase solution at ambient conditions because the use of a protective moiety on the developer prevents the color-forming reaction from occurring prior to activation. Nonetheless, in other embodiments, one or the other of the components may be substantially insoluble in the matrix at ambient conditions. By “substantially insoluble,” it is meant that the solubility of that component of the color-forming agent 240 in the matrix at ambient conditions is so low, that no or very little color change occurs due to reaction of the dye and the developer at ambient conditions. Thus, in some embodiments, the developer is dissolved in the matrix with the dye being present as small crystals suspended in the matrix at ambient conditions; while in other embodiments, the color-former is dissolved in the matrix and the developer is present as small crystals suspended in the matrix at ambient conditions. When a two-phase system is used, the particle size is ½λ (wavelength) of the radiation in some embodiments, and less than 400 nm in other embodiments.

Laser light having blue, indigo, red and far-red wavelength ranges from about 380 nm to about 420 nm; or from about 630 nm to about 680 nm; or from about 770 nm to about 810 nm can be used to develop the present color-forming compositions. Therefore, color-forming compositions may be selected for use in devices that emit wavelengths within this range. For example, if the light source emits light having a wavelength of about 405 nm, the precursor can be selected to absorb and rearrange at or near that wavelength. In other embodiments, light sources of other wavelengths, including but not limited to 650 nm or 780 nm, can be used. In either case, a radiation absorber tuned to the selected wavelength can be included so as to enhance localized heating. Radiation absorbers suitable for this purpose are known.

In some embodiments, for example, the light source may operate within a range of wavelengths from about 770 nm to about 810 nm. In general, in addition to the ranges given above, any of the ranges of light source displayed in Table 1 may be used to develop contrast in embodiments of the present disclosure.

TABLE 1

| Laser Sources | | | Emission, | | | | | |
|---|---|---|---|---|---|---|---|---|
| Wavelength | | | perpendicular | Light Output | | Voltage | Input | |
| min | typ | max | Angle | Emission) | Current | nominal | Power | Efficiency |
| nm | Nm | nm | Degrees | mW | mA | V | mW | % |
| 370 | 375 | 380 | 24 | 10 | 70 | 5 | 350 | 3% |
| 400 | 408 | 415 | 23 | 30 | 45 | 4.5 | 203 | 15% |
| 435 | 440 | 445 | 22 | 20 | 40 | 5 | 200 | 10% |
| 468 | 473 | 478 | 22 | 5 | 40 | 5 | 200 | 3% |
| 650 | 656 | 660 | 22 | 50 | 80 | 2.6 | 208 | 24% |
| 780 | 784 | 787 | 16 | 100 | 141 | 2.1 | 296 | 34% |
| 970 | 980 | 990 | 18 | 200 | 270 | 1.76 | 475 | 42% |
| 1520 | 1550 | 1580 | 18 | 10 | 50 | 3 | 150 | 7% |

Common CD-burning lasers have a wavelength of about 780 nm and can be adapted for use as a radiation sources in conjunction with embodiments of the present disclosure. Examples of radiation absorbers that are suitable for use in the infrared range can include, but are not limited to, polymethyl indoliums, metal complex IR dyes, indocyanine green, polymethine dyes such as pyrimidinetrione-cyclopentylidenes, guaiazulenyl dyes, croconium dyes, cyanine dyes, squarylium dyes, chalcogenopyryloarylidene dyes, metal thiolate complex dyes, bis(chalcogenopyrylo)polymethine dyes, oxyindolizine dyes, bis(aminoaryl)polymethine dyes, indolizine dyes, pyrylium dyes, quinoid dyes, quinone dyes, phthalocyanine dyes, naphthalocyanine dyes, azo dyes, hexfunctional polyester oligomers, heterocyclic compounds, and combinations thereof. Several specific polymethyl indolium compounds are available from Aldrich Chemical Company and include 2-[2-[2-chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium perchlorate; 2-[2-[2-Chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium chloride; 2-[2-[2-chloro-3-[(1,3-dihydro-3,3-dimethyl-1-propyl-2H-indol-2-ylidene)ethylidene]-11-cyclohexen-1-yl]ethenyl]-3,3-dimethyl-1-propylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium perchlorate; 2-[2-[3-[(1,3-dihydro-3,3-dimethyl-1-propyl-2H-indol-2-ylidene)ethylidene-]-2-(phenylthio)-1-cyclohexen-1-yl]ethenyl]-3,3-dimethyl-1-propylindolium perchlorate; and mixtures thereof. Alternatively, the radiation absorber can be an inorganic compound, e.g., ferric oxide, carbon black, selenium, or the like. Polymethine dyes or derivatives thereof (such as a pyrimidinetrione-cyclopentylidene), squarylium dyes (such as guaiazulenyl dyes), croconium dyes, or mixtures thereof can also be used. Suitable infrared sensitive pyrimidinetrione-cyclopentylidene radiation absorbers include, for example, 2,4,6(1 H,3H,5H)-pyrimidinetrione 5-[2,5-bis[(1,3-dihydro-1,1,3-dimethyl-2H-indol-2-ylidene)ethylidene]cyclopentylidene]-1,3-dimethyl-(9Cl) (S0322 available from Few Chemicals, Germany).

In other embodiments, a radiation absorber can be included that preferentially absorbs wavelengths in the range from about 600 nm to about 720 nm and more specifically at about 650 nm. Non-limiting examples of suitable radiation absorbers for use in this range of wavelengths can include indocyanine dyes such as 3H-indolium, 2-[5-(1,3-dihydro-3,3-dimethyl-1-propyl-2H-indol-2-ylidene)-1,3-pentadienyl]-3,3-dimethyl-1-propyl-iodide), 3H-indolium, 1-butyl-2-[5-(1-butyl-1,3-dihydro-3,3-dimethyl-2H-indol-2-ylidene)-1,3-pentadienyl]-3,3-dimethyl-perchlorate, and phenoxazine derivatives such as phenoxazin-5-ium, 3,7-bis(diethylamino)perchlorate. Phthalocyanine dyes such as silicon 2,3-napthalocyanine bis(trihexylsilyloxide) and matrix soluble derivatives of 2,3-napthalocyanine (both commercially available from Aldrich Chemical), matrix soluble derivatives of silicon phthalocyanine (as described in Rodgers, A. J. et al., 107 J. Phys. Chem. A 3503-3514, May 8, 2003), matrix soluble derivatives of benzophthalocyanines (as described in Aoudia, Mohamed, 119 J. Am. Chem. Soc. 6029-6039, Jul. 2, 1997), phthalocyanine compounds such as those described in U.S. Pat. Nos. 6,015,896 and 6,025,486 (which are each incorporated herein by reference), and Cirrus 715, a phthalocyanine dye available from Avecia, Manchester, England, may also be used.

In still other embodiments, a radiation source, such as a laser or LED, that emits light having blue and indigo wavelengths ranging from about 380 nm to about 420 nm may be used. In particular, radiation sources such as the lasers used in certain DVD and laser disk recording equipment emit energy at a wavelength of about 405 nm. Radiation absorbers that most efficiently absorb radiation in these wavelengths may include, but are not limited to, aluminum quinoline complexes, porphyrins, porphins, and mixtures or derivatives thereof. Some specific examples of suitable radiation absorbers suitable for use with radiation sources that output radiation between 380 and 420 nm include 1-(2-chloro-5-sulfophenyl)-3-methyl-4-(4-sulfophenyl)azo-2-pyrazolin-5-one disodium salt; ethyl 7-diethylaminocoumarin-3-carboxylate; 3,3′-diethylthiacyanine ethylsulfate; 3-allyl-5-(3-ethyl-4-methyl-2-thiazolinylidene)rhodanine (each available from Organica Feinchemie GmbH Wolfen), and mixtures thereof. Other examples of suitable radiation absorbers include aluminum quinoline complexes such as tris(8-hydroxyquinolinato)aluminum (CAS 2085-33-8) and derivatives such as tris(5-cholor-8-hydroxyquinolinato)aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3), 4,4′-[1,4-phenylenebis(1,3,4-oxadiazole-5,2-diyl)]bis N,N-diphenyl benzeneamine (CAS 184101-38-0), bis-tetraethylammonium-bis(1,2-dicyano-dithiolto)-zinc(II) (CAS 21312-70-9), 2-(4,5-dihydronaphtho[1,2-d]-1,3-dithiol-2-ylidene)-4,5-dihydro-naphtho[1-,2-d]1,3-dithiole, all available from Syntec GmbH. Other examples of specific porphyrin and porphyrin derivatives can include etioporphyrin 1 (CAS 448-71-5), deuteroporphyrin IX 2,4 bis ethylene glycol (D630-9) available from Frontier Scientific, and octaethyl porphrin (CAS 2683-82-1), azo dyes such as Mordant Orange CAS 2243-76-7, Methyl Yellow (60-11-7), 4-phenylazoaniline (CAS 60-09-3), Alcian Yellow (CAS 61968-76-1), available from Aldrich chemical company, and mixtures thereof.

The matrix material can be any composition suitable for dissolving and/or dispersing the developer, and color-former (or color-former/melting aid alloy). Acceptable matrix materials include, by way of example, UV-curable matrices such as acrylate derivatives, oligomers and monomers, with or without a photo package. A photo package may include a light-absorbing species which initiates reactions for curing of a matrix, such as, by way of example, benzophenone derivatives. Other examples of photoinitiators for free radical polymerization monomers and pre-polymers include, but are not limited to, thioxanethone derivatives, anthraquinone derivatives, acetophenones and benzoine ether types. It may be desirable to choose a matrix that can be cured by a form of radiation other than the type of radiation that causes a color change.

Matrices based on cationic polymerization resins may require photo-initiators based on aromatic diazonium salts, aromatic halonium salts, aromatic sulfonium salts and metallocene compounds. An example of an acceptable matrix or matrices includes Nor-Cote CLCDG-1250A or Nor-Cote CDG000 (mixtures of UV curable acrylate monomers and oligomers), which contains a photoinitiator (hydroxy ketone) and organic solvent acrylates (e.g., methyl methacrylate, hexyl methacrylate, beta-phenoxy ethyl acrylate, and hexamethylene acrylate). Other acceptable matrixes or matrices include acrylated polyester oligomers such as CN292, CN293, CN294, SR351 (trimethylolpropane tri acrylate), SR395 (isodecyl acrylate), and SR256 (2(2-ethoxyethoxy)ethyl acrylate) available from Sartomer Co.

The ability of the deprotection agents to de-protect the developers is limited when the solid matrix is below its glass transition temperature (T_{g}). Thus, in some embodiments, it is preferred to provide sufficient photothermal energy in the region of the desired mark to locally heat the matrix above a threshold temperature, which may be its glass transition temperature T_{g}. T_{g} typically depends on the polymer composition of the matrix, and can be selected, if desired, by selecting the polymer that is used for the matrix. In some embodiments, T_{g} will preferably be in the range of 90 to 200° C. More preferred ranges are 120-140° C., with some embodiments being markable at 95° C.

The imaging compositions formed in the manner described herein can be applied to the surface of an optical recording medium such as a CD, DVD, HD-DVD, BLU-RAY disc or the like. Further, discs incorporating embodiments of the present disclosure can be used in systems that include optical recording and/or reading capabilities. Such systems typically include a laser emitting light having a predetermined wavelength and power. Systems that include optical reading capability further include an optical pickup unit coupled to the laser. Lasers and optical pickup units are known in the art.

Referring again to FIGS. 1 and 2, an exemplary read/write system 170 includes a processor 166, a laser 150, and an optical pickup 157. Signals 163 from processor 166 cause laser 150 to emit light at the desired power level. Light reflected from the disc surface is detected by pickup 157, which in turn sends a corresponding signal 165 back to processor 166.

When it is desired to record a disc 100 incorporating an embodiment of the present disclosure, the disc 100 is positioned such that light emitted by laser 150 is incident on the marking surface. The laser 150 is operated such that the light incident on the marking layer transfers sufficient energy to the surface to cause a mark, such as at 242. Both the laser 150 and the position of the disc 100 are controlled by a processor 166 such that light is emitted by the laser in pulses that form a pattern of marks 242 on the surface of the disc 100.

When it is desired to read a pattern of marks on the surface of a disc 100, the disc 100 is again positioned such that light emitted by laser 150 is incident on the marked surface. The laser 150 is operated such that the light incident at the surface does not transfer sufficient energy to the surface to cause a mark. Instead the incident light is reflected from the marked surface to a greater or lesser degree, depending on the absence or presence of a mark. As the disc 100 moves, changes in reflectance are recorded by optical pickup 157 which generates a signal 165 corresponding to the marked surface. Both the laser 150 and the position of the disc 100 are controlled by the processor during the reading process.

It will be understood that the read/write system described herein is merely exemplary and includes components that are understood in the art. Various modifications can be made, including the use of multiple lasers, processors, and/or pickups, and/or the use of light having different wavelengths. The read components may be separated from the write components, or may be combined in a single device. In some embodiments, discs incorporating embodiments of the present disclosure can be used with optical read/write equipment operating at wavelengths ranging between 380 nm and 420 nm.

To further illustrate the embodiment(s) of the present disclosure, examples are given herein. It is to be understood that these examples are provided for illustrative purposes and are not to be construed as limiting the scope of the disclosed embodiment(s).

### EXAMPLES

### Example 1

A dispersion of 8 WT % Leuco dye, Specialty yellow 37, available from Noveon Corporation, Cincinnati, Ohio; 0.2 wt % s0511 absorber (Few Chemicals, Germany), 10 wt % 2-hydroxy-1-amino-propanol, 25 wt % acetyl TG-SA (protected activator), 20 wt % cellulose butyl acetate as a binder, with the balance being methyl ethyl ketone as prepared. The color forming solution was applied to a glass substrate and dried under vacuum to form a film. Light energy was then applied using a laser of 405 nm band at about 11 mW power for about 100 microseconds. The following reaction resulted in intense yellow color dots having an optical density greater than 0.2 Abs units at 405 nm band.

### Example 2

A dispersion of 5 wt % Leuco dye NC Yellow 3, (available from Hodogaya Corporation, Japan); 10 wt %-hydroxy-1-amino-propanol, 25 wt % acetyl TG-SA (protected activator), and 0.2% S0511 absorber (Few Chemicals, Germany) in 45 wt % CDG000 UV curable binder available from Nor cote Inc. was prepared. The color forming dispersion was applied to a polycarbonate substrate, and the resulting film was cured using UV radiation. Light energy was then applied using a laser of 405 nm band at about 11 mmW power for about 100 microseconds. A similar reaction as shown in Example 1 resulted in intense black color dots having an optical density of 0.4 Abs units at 405 nm band.

It is to be understood that the above examples and discussion are meant to be illustrative of the principles and embodiments of the present disclosure. While several embodiments have been described in detail, it will be apparent to those skilled in the art that the disclosed embodiments may be modified. Therefore, the foregoing description is to be considered exemplary rather than limiting.

What is claimed is:

1. An optical data recording medium, comprising:
a substrate; and
a markable coating on the substrate, the markable coating including a radiation absorber, a leuco dye, a developer and a deprotection agent.

2. The optical data recording medium according to claim 1, wherein the developer includes a phenolic compound protected by an acyl protective moiety, wherein the deprotection agent includes an amine, and wherein elevation of the markable coating above a threshold temperature by adding radiation of a predetermined wavelength causes the acyl protective moiety to be removed by the deprotection agent, resulting in a deprotected developer that reacts with the leuco dye.

3. The optical data recording medium according to claim 1, wherein the radiation absorber has an absorption wavelength range selected from the group consisting of about 370 nm to about 380 nm, about 380 nm to about 420 nm, about 400 nm to about 415 nm, about 68 nm to about 478 nm, about 650 nm to about 660 nm, about 780 nm to about 787 nm, about 970 nm to about 990 nm, and about 1520 nm to about 1580 nm.

4. The optical data recording medium according to claim 1, wherein the leuco dye, the developer and the deprotecting agent substantially dissolve in a matrix and, alone or in combination with each other, form substantially no particles in the matrix.

5. The optical data recording medium according to claim 2, wherein the predetermined wavelength of the added radiation ranges from about 380 nm to about 420 nm.

6. The optical data recording medium according to claim 1, wherein the markable coating forms an optically readable marking layer on the medium, the layer having a thickness of 1 micron or less.

7. The optical data recording medium according to claim 1, wherein if the leuco dye, the developer and the deprotection agent, alone or in combination with each other, form particles in a matrix, the particles are 1 micron or less in size.

8. The optical data recording medium according to claim 6, wherein the optically readable marking layer is transparent.

9. The optical data recording medium according to claim 1, wherein the leuco dye, the developer and the deprotection agent are present in a matrix.

10. A color-forming agent in a markable coating for an optical data recording medium, the color-forming agent comprising:
a leuco dye;
a developer; and
a deprotection agent;
wherein the markable coating includes a radiation absorber.

11. The color-forming agent according to claim 10, wherein the developer includes a phenolic compound protected by an acyl protective moiety, wherein the deprotection agent includes an amine, and wherein elevation of a matrix including the color-forming agent above a threshold temperature by adding radiation of a predetermined wavelength causes the acyl protective moiety to be removed by the deprotection agent, resulting in a deprotected developer that reacts with the leuco dye.

12. The color-forming agent according to claim 10, wherein if the leuco dye, the developer and the deprotection agent, alone or in combination with each other, form particles in a matrix, the particles are 1 micron or less in size.

13. The color-forming agent according to claim 10, wherein the leuco dye, the developer and the deprotection agent substantially dissolve in a matrix and, alone or in combination with each other, form substantially no particles in the matrix.

14. The color-forming agent according to claim 10, wherein the coating forms a layer of 1 micron or less thickness on the optical data recording medium.

15. The color-forming agent according to claim 14, wherein the layer is transparent.

16. The color-forming agent according to claim 10, wherein the predetermined wavelength of the added radiation is selected from the group consisting of about 370 nm to about 380 nm, about 380 nm to about 420 nm, about 400 nm to about 415 nm, about 468 nm to about 478 nm, about 650 nm to about 660 nm, about 780 nm to about 787 nm, about 970 nm to about 990 nm, and about 1520 nm to about 1580 nm.

17. The color-forming agent according to claim 16, wherein the predetermined wavelength of the added radiation ranges from about 380 nm to about 420 nm.

18. A method for optically recording data, comprising:
providing an optical recording medium including a substrate coated with a markable coating, the markable coating including a radiation absorber, a leuco dye, a developer and a deprotection agent; and
using effecting radiation having a predetermined wavelength to form an optically detectable mark in the markable coating.

19. The method according to claim 18, wherein the developer includes a phenolic compound protected by an acyl protective moiety and the deprotection agent includes an amine.

20. The method according to claim 18, wherein the leuco dye, the developer and the deprotection agent substantially dissolve in a matrix and, alone or in combination with each other, form substantially no particles in the matrix.

21. The method according to claim 18, wherein the effecting radiation has a wavelength range selected from the group consisting of about 370 nm to about 380 nm, about 380 nm to about 420 nm, about 400 nm to about 415 nm, about 468 nm to about 478 nm, about 650 nm to about 660 nm, about 780 nm to about 787 nm, about 970 nm to about 990 nm, and about 1520 nm to about 1580 nm.

22. The method according to claim 18, wherein the effecting radiation has a wavelength ranging from about 380 nm to about 420 nm.

23. The method according to claim 18, wherein if the leuco dye, the developer and the deprotection agent, alone or in combination with each other, form particles in a matrix, the particles are 1 micron or less in size.

24. The method according to claim 18, wherein the coating forms a layer of 1 micron or less thickness on the optical recording medium.

25. The method according to claim 24, wherein the layer is transparent.

26. The method according to claim 18, further comprising incorporating the leuco dye, the developer and the deprotection agent into a matrix.

27. An optical recording system, comprising:
a disc including a substrate and a markable coating on the substrate, the markable coating including a radiation absorber, a leuco dye, a developer and a deprotection agent; and
a light source positioned so as to illuminate the disc in a desired manner so as to cause localized heating that causes the protective moiety to move from the developer such that the developer reacts with the leuco dye.

28. The optical recording system according to claim 27, wherein the developer includes a phenolic compound protected by an acyl protective moiety and the deprotection agent includes an amine.

29. The optical recording system according to claim 27, wherein the light source provides light having a wavelength range selected from the group consisting of about 370 nm to about 380 nm, about 380 nm to about 420 nm, about 400 nm to about 415 nm, about 468 nm to about 478 nm, about 650 nm to about 660 nm, about 780 nm to about 787 nm, about 970 nm to about 990 nm, and about 1520 nm to about 1580 nm.

30. The optical recording system according to claim 29, wherein the light source provides light having a wavelength range from about 380 nm to about 420 nm.

31. The optical recording system according to claim 27, wherein the leuco dye, the developer and the deprotection agent substantially dissolve in a matrix and, alone or in combination with each other, form substantially no particles in the matrix.

32. The optical recording system according to claim 27, wherein if the leuco dye, the developer and the deprotection agent, alone or in combination with each other, form particles in the matrix, the particles are 1 micron or less in size.

33. The optical recording system according to claim 27, wherein the coating forms a layer of 1 micron or less thickness on an optical data recording medium.

34. The optical recording system according to claim 33, wherein the layer is transparent.

35. The optical recording system according to claim 27, wherein the leuco dye, the developer and the deprotection agent are present in a matrix.

36. A method of making an optical data recording medium, comprising:
providing a substrate; and
providing a markable coating on the substrate, the markable coating including a radiation absorber, a leuco dye, a developer and a deprotection agent.

37. The method according to claim 36, wherein the developer includes a phenolic compound protected by an acyl protective moiety, wherein the deprotection agent includes an amine, and wherein elevation of the markable coating above a threshold temperature by adding effecting radiation of a predetermined wavelength causes the acyl protective moiety to move to the deprotection agent, resulting in a deprotected developer that reacts with the leuco dye.

38. The method according to claim 36, wherein if the leuco dye, the developer and the deprotection agent, alone or in combination with each other, form particles in a matrix, the particles are 1 micron or less in size.

39. The method according to claim 36, wherein the leuco dye, the developer and the deprotection agent substantially dissolve in a matrix and, alone or in combination with each other, form substantially no particles in the matrix.

40. The method according to claim 36, wherein the coating forms a layer of 1 micron or less thickness on the optical data recording medium.

41. The method according to claim 40, wherein the layer is transparent.

42. The method according to claim 36, wherein the radiation absorber has an absorption band wavelength range selected from the group consisting of about 370 nm to about 380 nm, about 380 nm to about 420 nm, about 400 nm to about 415 nm, about 468 nm to about 478 nm, about 650 nm to about 660 nm, about 780 nm to about 787 nm, about 970 nm to about 990 nm, and about 1520 nm to about 1580 nm.

43. The method according to claim 37, wherein the effecting radiation has a wavelength range selected from the group consisting of about 370 nm to about 380 nm, about 380 nm to about 420 nm, about 400 nm to about 415 nm, about 468 nm to about 478 nm, about 650 nm to about 660 nm, about 780 nm to about 787 nm, about 970 nm to about 990 nm, and about 1520 nm to about 1580 nm.

44. The method according to claim 43, wherein the effecting radiation has a wavelength range of about 380 nm to about 420 nm.

45. The method according to claim 36, wherein the leuco dye, the developer and the deprotection agent are present in a matrix.

46. An apparatus for recording optical data, comprising:
an optical data recording medium including a substrate and a markable coating on the substrate, the markable coating including a radiation absorber, a leuco dye, a developer and a deprotection agent; and
a recording device including a light source.

47. The apparatus according to claim 46, wherein the developer includes a phenolic compound protected by an acyl protective moiety and the deprotection agent includes an amine; and wherein elevation of the markable coating above a threshold temperature causes the acyl protective moiety to move to the deprotection agent, resulting in a deprotected developer that reacts with the leuco dye.

48. The apparatus according to claim 46, wherein the light source emits light having a wavelength range selected from the group consisting of about 370 nm to about 380 nm, about 380 nm to about 420 nm, about 400 nm to about 415 nm, about 468 nm to about 478 nm, about 650 nm to about 660 nm, about 780 nm to about 787 nm, about 970 nm to about 990 nm, and about 1520 nm to about 1580 nm.

49. The apparatus according to claim 48, wherein the light source emits light having a wavelength ranging from about 380 nm to about 420 nm.

50. The apparatus according to claim 46, wherein the leuco dye, the developer and the deprotection agent substantially dissolve in a matrix and, alone or in combination with each other, form substantially no particles in the matrix.

51. The apparatus according to claim 46, further including a sensor for detecting an optical mark on the optical data recording medium.

52. The apparatus according to claim 46, wherein the markable coating forms an optically readable marking layer on the medium, the layer being 1 micron or less thick.

53. The apparatus according to claim 52, wherein the optically readable marking layer is transparent.

54. The apparatus according to claim 46, wherein if the leuco dye, the developer and the deprotection agent, alone or in combination with each other, form particles in a matrix, the particles are 1 micron or less in size.

55. The apparatus according to claim 46, wherein the radiation absorber has an absorption band wavelength range selected from the group consisting of about 370 nm to about 380 nm, about 380 nm to about 420 nm, about 400 nm to about 415 nm, about 468 nm to about 478 nm, about 650 nm to about 660 nm, about 780 nm to about 787 nm, about 970 nm to about 990 nm, and about 1520 nm to about 1580 nm.

56. The apparatus according to claim 46, wherein the leuco dye, the developer and the deprotection agent are present in a matrix.

57. A method for reading optically recorded data, comprising:
providing an optical recording medium including a substrate coated with at least one markable coating, the at least one markable coating including a radiation absorber, a leuco dye, a developer and a deprotection agent;
using light radiation below a wavelength suitable for forming an optically detectable mark in the at least one markable coating, the light radiation illuminating and reflecting light from previously formed optically detectable marks;
detecting, by a sensor, at least one readable pattern of the optically detectable marks illuminated by the light radiation on the optical recording medium, the sensor reading the at least one readable pattern as the optical recording medium moves in relation to the sensor; and
sending from the sensor to a processor at least one signal based on the at least one readable pattern detected by the sensor from the optical recording medium.

58. The method according to claim 57, wherein the developer includes a phenolic compound protected by an acyl protective moiety and the deprotection agent includes an amine.

59. The method according to claim 57, wherein prior to using light radiation, the method further comprises forming the optically detectable marks in the at least one markable coating.

60. The method according to claim 57, further comprising:
analyzing the at least one signal sent to the processor so that the at least one signal can be collected as data in a computer;
collecting the data in a computer data base; and
accessing the data in the computer data base.

61. The method according to claim 57, wherein the light radiation has a wavelength below 420 nm.

62. The method according to claim 57, wherein the light radiation has a wavelength range from about 380 nm to about 420 nm.

63. The method according to claim 57, wherein the leuco dye, the developer and the deprotection agent are present in a matrix.

64. An optical transmitting system, comprising:
a disc including a substrate and a markable coating on the substrate, the markable coating including a radiation absorber, a leuco dye, a developer and a deprotection agent, wherein the developer includes a phenolic compound protected by an acyl protective moiety and the deprotection agent includes an amine, wherein optically detectable marks have been formed in the markable coating;
a light source positioned so as to illuminate with light the disc in a desired manner so as to cause at least one of the optically detectable marks to reflect light from the light source, the light from the light source having radiation below a wavelength suitable for forming an optically detectable mark in the markable coating;
a sensor positioned so as to detect at least one readable pattern of the at least one of the optically detectable marks illuminated by the light, the sensor reading the at least one readable pattern as the disc moves in relation to the sensor;
a processor to which the sensor sends at least one signal based on the at least one readable pattern detected by the sensor;
an analyzer to which the processor sends the at least one signal to analyze so that the at least one signal can be collected and stored as data; and
a computer data base to which the analyzer sends the data from the at least one signal for collecting and storing and from which the data can be accessed.

65. The optical transmitting system according to claim 64, wherein the light source provides light having a wavelength range selected from the group consisting of about 370 nm to about 380 nm, about 380 nm to about 420 nm, about 400 nm to about 415 nm, about 468 nm to about 478 nm, about 650 nm to about 660 nm, about 780 nm to about 787 nm, about 970 nm to about 990 nm, and about 1520 nm to about 1580 nm.

66. The optical transmitting system according to claim 64, wherein the light source provides light having a wavelength range from about 380 nm to about 420 nm.

67. The optical transmitting system according to claim 64, wherein the leuco dye, the developer and the deprotection agent are present in a matrix.

68. An apparatus for transmitting optical data, comprising:
a disc including a substrate and a markable coating on the substrate, the markable coating including a radiation absorber, a color-forming agent including a leuco dye, a developer and a deprotection agent;
a light source positioned so as to illuminate with light the disc in a desired manner so as to cause at least one optically detectable mark formed in the markable coating to reflect light from the light source, the light from the light source illuminating the disc with radiation below a wavelength suitable for forming an optically detectable mark in the markable coating;
a sensor positioned so as to detect at least one readable pattern of the at least one optically detectable mark, the sensor reading the at least one readable pattern as the disc moves in relation to the sensor; and
a processor to which the sensor sends at least one signal based on the at least one readable pattern detected by the sensor.

69. The apparatus according to claim 68, wherein the developer includes a phenolic compound protected by an acyl protective moiety, and the deprotection agent includes an amine.

70. The apparatus according to claim 68, wherein the light source beams light with a wavelength range selected from the group consisting of about 370 nm to about 380 nm, about 380 nm to about 420 nm, about 400 nm to about 415 nm, about 468 nm to about 478 nm, about 650 nm to about 660 nm, about 780 nm to about 787 nm, about 970 nm to about 990 nm, and about 1520 nm to about 1580 nm.

71. The apparatus according to claim 68, wherein the light source beams light with a wavelength range from about 380 nm to about 420 nm.

72. The apparatus according to claim 68, wherein the leuco dye, the developer and the deprotection agent are present in a matrix.
